(19) United States
(12) Patent Application Publication
(10) Pub. No.: US 2026/0001338 A1
(43) Pub. Date: Jan. 1, 2026

(54) CARTRIDGE AND LIQUID SUPPLY SYSTEM

(71) Applicant: SEIKO EPSON CORPORATION, Tokyo (JP)

(72) Inventors: Shun OYA, Kiso-machi (JP); Yoshihiro KOIZUMI, Shlojiri-shi (JP); Kazuhiko SATO, Matsumoto-shi (JP)

(73) Assignee: SEIKO EPSON CORPORATION, Tokyo (JP)

(21) Appl. No.: 19/249,192

(22) Filed: Jun. 25, 2025

(30) Foreign Application Priority Data
Jun. 26, 2024 (JP) 2024-102465

(51) Int. Cl. B41J 2/175

(52) U.S. Cl. CPC B41J 2/17523; B41J 2/1754; B41J 2/17553

(57) ABSTRACT

A cartridge includes a liquid accommodating portion configured to accommodate liquid, a supply port member having a supply port that communicates with the liquid accommodating portion and supplies the liquid to an outside of the liquid accommodating portion, a first sealing member provided on an inner peripheral surface of the supply port, a covering member configured to cover a portion of an opening surface of the supply port from an outside of the supply port, and a second sealing member configured to seal a leakage path of the liquid outside the supply port, the leakage path being a gap between elements included in the cartridge.

The present application is based on, and claims priority from JP Application Serial Number 2024-102465, filed Jun. 26, 2024, the disclosure of which is hereby incorporated by reference herein in its entirety.

### BACKGROUND

### 1. Technical Field

The present disclosure relates to a cartridge and a liquid supply system.

### 2. Related Art

Japanese Patent No. 3161478 discloses an ink outlet including a plurality of sealing members disposed in an ink take-out port of a cartridge. Each sealing member seals between the ink outlet and an ink supply needle provided in a recording apparatus in which the cartridge is mounted.

In the technique of Japanese Patent No. 3161478, each sealing member can suppress leakage of liquid from the ink outlet, and can suppress the leakage of the liquid from the cartridge to the outside. A technique that can more reliably suppress the leakage of the liquid from the cartridge is desired.

### SUMMARY

According to a first aspect of the present disclosure, there is provided a cartridge. The cartridge includes a liquid accommodating portion configured to accommodate liquid, a supply port member having a supply port that communicates with the liquid accommodating portion and supplies the liquid to an outside of the liquid accommodating portion, a first sealing member provided on an inner peripheral surface of the supply port, a covering member configured to cover a portion of an opening surface of the supply port from an outside of the supply port, and a second sealing member configured to seal a leakage path of the liquid outside the supply port, the leakage path being a gap between elements included in the cartridge.

According to a second aspect of the present disclosure, there is provided a liquid supply system. The liquid supply system includes the cartridge according to the above aspect, a mounting portion configured to mount the cartridge, the mounting portion including a receiving portion configured to receive the supply port member and the covering member, and a third sealing member configured to seal between the receiving portion and the covering member.

### BRIEF DESCRIPTION OF THE DRAWINGS

FIG. 1 is a schematic configuration diagram of a liquid ejecting system.

FIG. 2 is a first external perspective view of a cartridge mounting portion.

FIG. 3 is a second external perspective view of the cartridge mounting portion.

FIG. 4 is an external perspective view of a cartridge.

FIG. 5 is an exploded perspective view of the cartridge.

FIG. 6 is a diagram in which a second case is removed from the cartridge.

FIG. 7 is a first external perspective view of a front surface side of the cartridge.

FIG. 8 is a front view of the cartridge.

FIG. 9 is a cross-sectional view taken along line IX-IX in FIG. 8.

FIG. 10 is a cross-sectional view of a vicinity of a liquid flow-out portion shown in FIG. 9.

FIG. 11 is a cross-sectional view of the vicinity of the liquid flow-out portion according to a second embodiment.

### DESCRIPTION OF EMBODIMENTS

### A. First Embodiment

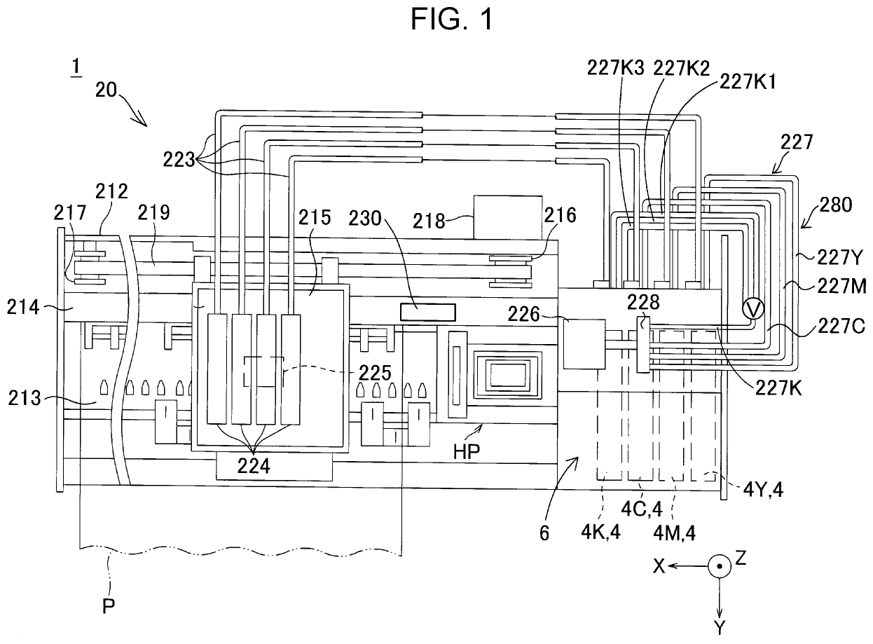

FIG. 1 is a schematic configuration diagram of a liquid ejecting system 1 as a first embodiment. FIG. 1 shows XYZ axes which are three spatial axes orthogonal to each other. Directions in which arrows of the X-axis, the Y-axis, and the Z-axis are directed indicate positive directions along the X-axis, the Y-axis, and the Z-axis, respectively. The positive directions along the X-axis, the Y-axis, and the Z-axis are a +X direction, a +Y direction, and a +Z direction, respectively. Directions opposite to the directions in which the arrows of the X-axis, the Y-axis, and the Z-axis are directed indicate negative directions along the X-axis, the Y-axis, and the Z-axis, respectively.

The negative directions along the X-axis, the Y-axis, and the Z-axis are a −X direction, a −Y direction, and a −Z direction, respectively. When positiveness and negativeness in directions along the X-axis, the Y-axis, and the Z-axis do not matter, the directions may be referred to as an X direction, a Y direction, and a Z direction, respectively. The same applies to the drawings and descriptions shown below. The directions of the XYZ axes drawn in other drawings correspond to the directions of the XYZ axes of FIG. 1. In a use state of the liquid ejecting system 1, the +Z direction is a vertical upward direction, and the −Z direction is a vertical downward direction. Here, the “use state of the liquid ejecting system 1” refers to a state in which the liquid ejecting system 1 is installed on a horizontal installation surface which is defined by the X direction and the Y direction.

The liquid ejecting system 1 includes a printer 20 as a liquid ejecting apparatus and four cartridges 4C, 4M, 4Y, and 4K. The printer 20 is an ink jet printer for ejecting ink as a liquid from a recording head 225 as a liquid ejecting portion. Here, when using the four cartridges 4C, 4M, 4Y, and 4K without distinction, the reference numeral “4” is used. The “use state of the liquid ejecting system 1” is also referred to as a “use state of the printer 20”.

The printer 20 includes a main body case 212 having a substantially rectangular box shaped and a control portion 230 disposed in the main body case 212. The control portion 230 controls various operations of the printer 20 and exchanges various signals with the cartridge 4. Various operations of the printer 20 include a printing operation of the printer 20.

In the main body case 212, a platen 213 is disposed along a longitudinal direction of the main body case 212. In the present embodiment, the longitudinal direction of the main body case 212 is the X direction. The platen 213 is a support table that supports recording paper P as an ejection target. The recording paper P is fed along a sub-scanning direction orthogonal to a main scanning direction on the platen 213 by a paper feeding mechanism (not shown). In the present embodiment, the main scanning direction is the X direction.

The printer 20 further includes a guide shaft 214, a carriage 215, a drive pulley 216, a driven pulley 217, and a carriage motor 218.

The guide shaft 214 is located on the +Z direction side with respect to the platen 213. The guide shaft 214 is a rod-shaped member along the main scanning direction. The carriage 215 is movably supported on the guide shaft 214 along the guide shaft 214.

The drive pulley 216 and the driven pulley 217 are located on the −Y direction side with respect to the guide shaft 214 and are rotatably disposed at positions corresponding to both end portions of the guide shaft 214. The carriage motor 218 is coupled to the drive pulley 216, and an endless timing belt 219 for supporting the carriage 215 is mounted between the pair of pulleys 216 and 217. Therefore, the carriage 215 can reciprocate along the guide shaft 214 in the main scanning direction by driving the carriage motor 218. In the present embodiment, the recording head 225 is configured to reciprocate in the main scanning direction, but the present disclosure is not limited to this. For example, the recording head 225 may be a line head that extends along the X direction with a fixed position.

The printer 20 further includes a cartridge mounting portion 6 for detachably mounting the cartridge 4. The cartridge mounting portion 6 is also simply referred to as a “mounting portion”. The cartridge mounting portion 6 is disposed inside the main body case 212. A portion of the main body case 212 is configured to be openable and closable. The cartridge 4 can be attached to and detached from the cartridge mounting portion 6 by opening the openable and closable portion. In the present embodiment, the cartridge mounting portion 6 is disposed inside the main body case 212, but the present disclosure is not limited to this. For example, the cartridge mounting portion 6 may be disposed outside the main body case 212.

The cartridge mounting portion 6 detachably mounts four cartridges 4C, 4M, 4K, and 4Y. The cartridge 4K accommodates black ink. The cartridge 4C accommodates cyan ink. The cartridge 4M accommodates magenta ink. The cartridge 4Y accommodates yellow ink. Each ink is a pigment ink containing a dispersion medium, such as water, and pigment particles. The printer 20 includes four liquid flow paths 223 corresponding to the four cartridges 4C, 4M, 4Y, and 4K. The liquid flow path 223 is a tube. The liquid flow path 223 causes the cartridge 4 and the recording head 225 to communicate with each other.

When the cartridge 4 is mounted in the cartridge mounting portion 6, the cartridge 4 is configured to be coupled to upstream ends of the respective corresponding liquid flow paths 223. The downstream ends of the respective liquid flow paths 223 are each coupled to the upstream of a valve unit 224 mounted on the carriage 215. The downstream of the valve unit 224 is coupled to the recording head 225 as a liquid ejecting head provided on a lower surface side of the carriage 215. That is, the ink accommodated in the cartridge 4 is supplied to the recording head 225 through the liquid flow path 223.

Between the cartridge mounting portion 6 and the platen 213, a home position HP, which is a retracted position of the recording head 225, is provided. Then, before the printing is started, various maintenance processes such as cleaning of the recording head 225 are executed at the home position HP.

The printer 20 further includes a pressurizing mechanism 280 for supplying pressurized fluid to the cartridge 4. The pressurizing mechanism 280 is disposed inside the main body case 212. The pressurizing mechanism 280 includes a pressurizing pump 226 which is a supply source of pressurized air as the pressurized fluid, and a plurality of fluid flow paths 227 for causing the pressurized air to flow to the cartridge 4.

The pressurizing pump 226 is coupled to an upstream end of the fluid flow path 227. The fluid flow path 227 is a tube. The fluid flow path 227 is branched at a distributor 228 disposed downstream of the pressurizing pump 226. The downstream ends of the branched fluid flow paths 227 are coupled to the respective corresponding cartridges 4.

Fluid flow paths 227C, 227M, and 227Y corresponding to the cartridges 4C, 4M, and 4Y are provided one by one. On the other hand, the fluid flow path 227K corresponding to the cartridge 4K is branched into three on the downstream (cartridge 4K side) of a valve V. The flow path branched into three is also referred to as a first fluid flow path 227K1, a second fluid flow path 227K2, and a third fluid flow path 227K3. The control portion 230 controls an operation of the pressurizing mechanism 280 such as the pressurizing pump 226 and the valve V, thereby supplying the pressurized fluid to the cartridge 4 through the fluid flow path 227.

The fluid flow paths 227K1, 227C, 227M, and 227Y cause pressurized air for supplying the ink accommodated in the cartridge 4 to the recording head 225 to flow. The fluid flow paths 227K1, 227C, 227M, and 227Y cause pressurized air to flow to a pressuring chamber of the cartridge 4, which will be described later. As a result, a liquid accommodating portion of the cartridge 4 is pressed. The ink is supplied to the recording head 225 through the liquid flow path 223 by pressing the liquid accommodating portion.

The second fluid flow path 227K2 and the third fluid flow path 227K3 cause pressurized air for stirring the liquid accommodating portion of the cartridge 4K to flow. Specifically, the second fluid flow path 227K2 and the third fluid flow path 227K3 cause pressurized air to flow to a stirring member of the cartridge 4K, which will be described later.

In the present embodiment, although three of fluid flow paths 227K corresponding to the cartridge 4K are provided, the present disclosure is not limited to this. For example, the number of the fluid flow paths 227K may be two or less, or may be four or more. In addition, in the present embodiment, the fluid flow paths 227C, 227M, and 227Y corresponding to the cartridges 4C, 4M, and 4Y are provided one by one, but the present disclosure is not limited to this. For example, three of the fluid flow paths may be provided, similar to the cartridge 4K, or any other number may be provided. In the present embodiment, pressurized air is fed from the common pressurizing pump 226 to each of the fluid flow paths 227K1, 227K2, 227K3, 227C, 227M, and 227Y, but the present disclosure is not limited to this. For example, a plurality of pressurizing pumps 226 may be provided corresponding to each of the fluid flow paths 227K1, 227K2, 227K3, 227C, 227M, and 227Y.

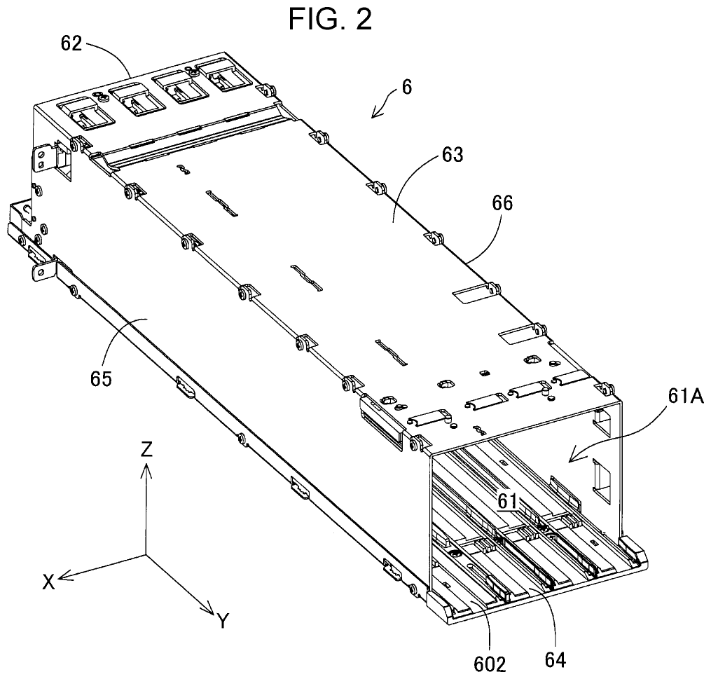

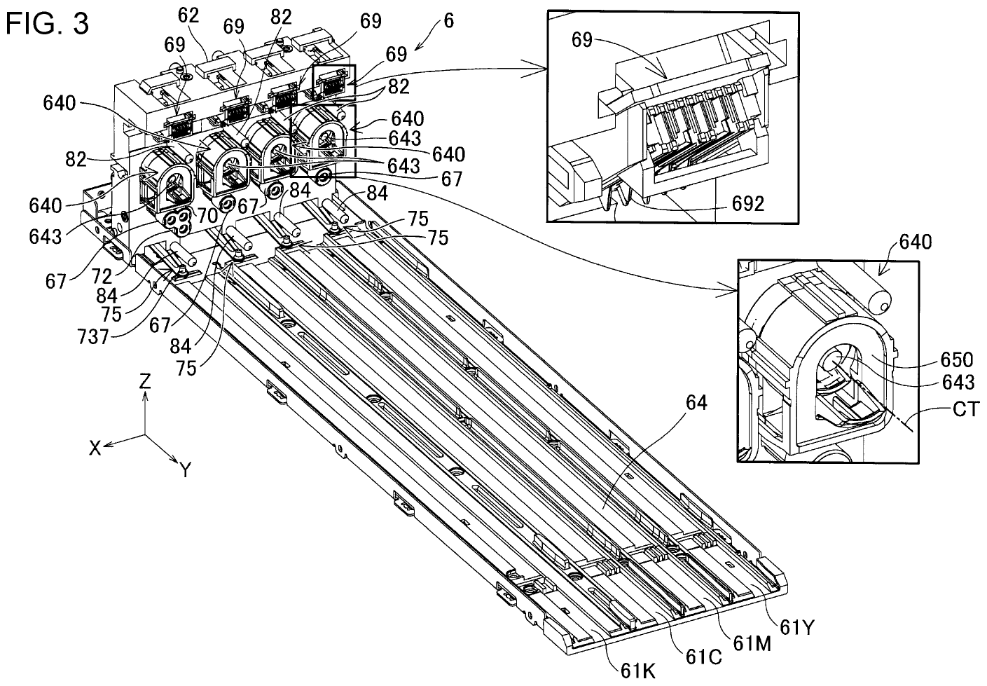

FIG. 2 is a first external perspective view of the cartridge mounting portion 6. FIG. 3 is a second external perspective view of the cartridge mounting portion 6. In FIG. 3, a portion of the configuration is omitted so that a configuration of the inside of the cartridge mounting portion 6 can be visually recognized. A mounting direction of the cartridge 4 to the cartridge mounting portion 6 is a −Y direction. A direction in which the cartridge 4 is removed from the cartridge mounting portion 6 is a +Y direction. That is, the cartridge 4 is removed from the cartridge mounting portion 6 by being pulled out from the cartridge mounting portion 6 in the +Y direction.

As shown in FIG. 2, the cartridge mounting portion 6 forms a cartridge accommodating chamber 61 for accommodating the cartridge 4 by six wall portions described below. The cartridge accommodating chamber 61 has a substantially rectangular parallelepiped shape. In the cartridge accommodating chamber 61, each portion that accommodates one of the four cartridges 4C, 4M, 4Y, and 4K is also referred to as a slot. Specifically, as shown in FIG. 3, a portion that accommodates the cartridge 4K is referred to as a slot 61K, a portion that accommodates the cartridge 4C is referred to as a slot 61C, a portion that accommodates the cartridge 4M is referred to as a slot 61M, and a portion that accommodates the cartridge 4Y is referred to as a slot 61Y.

The cartridge mounting portion 6 includes an apparatus-side front wall portion 62, a first apparatus-side side wall portion 63, and a second apparatus-side side wall portion 64. In addition, the cartridge mounting portion 6 includes a third apparatus-side side wall portion 65, a fourth apparatus-side side wall portion 66, and an opening wall portion 61A. The cartridge accommodating chamber 61 is partitioned formed by the apparatus-side front wall portion 62, the first apparatus-side side wall portion 63, the second apparatus-side side wall portion 64, the third apparatus-side side wall portion 65, the fourth apparatus-side side wall portion 66, and wall portion of the opening wall portion 61A. The outer shapes of the respective wall portions are a substantially rectangular shape.

As shown in FIGS. 2 and 3, the apparatus-side front wall portion 62 is located on a −Y direction side with respect to the cartridge accommodating chamber 61. The apparatus-side front wall portion 62 is a vertical wall portion in a use state of the printer 20.

As shown in FIG. 3, the cartridge mounting portion 6 includes an apparatus-side terminal portion 69, a receiving portion 640, a liquid supply pressurizing portion 67, a first apparatus-side positioning portion 82, a second apparatus-side positioning portion 84, and an apparatus-side fixing structure 75. The apparatus-side terminal portion 69, the receiving portion 640, the liquid supply pressurizing portion 67, the first apparatus-side positioning portion 82, the second apparatus-side positioning portion 84, and the apparatus-side fixing structure 75 are provided on the apparatus-side front wall portion 62. In addition, each of these portions is provided for each of the slots 61C, 61M, 61Y, and 61K corresponding to each of the cartridges 4C, 4M, 4Y, and 4K. In addition, the cartridge mounting portion 6 includes a first stirring pressurizing portion 70 and a second stirring pressurizing portion 72 corresponding to the cartridge 4K. The first stirring pressurizing portion 70 and the second stirring pressurizing portion 72 are provided on the apparatus-side front wall portion 62.

The apparatus-side terminal portion 69 is disposed vertically above the receiving portion 640. The apparatus-side terminal portion 69 has an apparatus-side terminal 692. In the present embodiment, the apparatus-side terminal portion 69 has a plurality of apparatus-side terminals 692. Specifically, the number of apparatus-side terminals 692 is nine. The apparatus-side terminal 692 is formed of an elastically deformable member. In the present embodiment, the apparatus-side terminal 692 is formed of a plate spring. The apparatus-side terminal 692 of the present embodiment is configured to be elastically deformable along a surface defined by the Y direction and the Z direction. The apparatus-side terminal 692 comes into contact with a cartridge-side terminal of the cartridge 4, which will be described later, so that it is electrically coupled to the cartridge-side terminal. The apparatus-side terminal portion 69 is electrically coupled to the control portion 230 of the printer 20 through wiring (not shown). As a result, in the mounted state in which the cartridge 4 is mounted in the cartridge mounting portion 6, various signals such as a signal related to the remaining amount of ink between the cartridge 4 and the control portion 230 can be exchanged.

The receiving portion 640 is configured to be able to receive a supply port member and a covering member of the cartridge 4, which will be described later. The receiving portion 640 includes a surrounding cover 650 and a liquid supply portion 643. The liquid supply portion 643 is used to cause the ink in the cartridge 4 to flow to a printer 20 side. The liquid supply portion 643 is tubular with a central axis CT extending along the Y direction. The liquid supply portion 643 is coupled to the cartridge 4. The liquid supply portion 643 is also referred to as a liquid receiving pipe.

The surrounding cover 650 surrounds the periphery of the liquid supply portion 643 in the XZ direction. The surrounding cover 650 is a member for reducing the possibility that the ink scatters to the outside when the cartridge 4 is attached and detached. The surrounding cover 650 is biased to a +Y direction side by a biasing member (not shown) included in the receiving portion 640. In the present embodiment, the biasing member is formed of a coil spring. The surrounding cover 650 is configured to be movable along the Y direction. When the cartridge 4 is mounted, the surrounding cover 650 moves in the −Y direction against the biasing force of the biasing member due to the cartridge 4 coming into contact with the surrounding cover 650. As a result, a +Y direction side end portion of the liquid supply portion 643 protrudes in the +Y direction side from the surrounding cover 650 and is coupled to the cartridge 4.

The liquid supply pressurizing portion 67 is a cylindrical member through which pressurized air flows as a pressurized fluid for supplying the ink of the cartridge 4 to the recording head 225. More specifically, the cartridge mounting portion 6 is provided with four liquid supply pressurizing portions 67 corresponding to the fluid flow paths 227K1, 227C, 227M, and 227Y shown in FIG. 1. The liquid supply pressurizing portions 67 are coupled to the downstream end portions of the corresponding fluid flow paths 227K1, 227C, 227M, and 227Y, respectively. In the mounted state of the cartridge 4, the liquid supply pressurizing portion 67 is coupled to the cartridge 4. A cylindrical sealing member is disposed on an inner peripheral surface of the liquid supply pressurizing portion 67. The sealing member is formed of rubber, for example.

As shown in FIG. 3, the first apparatus-side positioning portion 82 is a member that protrudes from the apparatus-side front wall portion 62 toward the +Y direction. The first apparatus-side positioning portion 82 is a cylindrical rod-shaped member. The first apparatus-side positioning portion 82 is located between the apparatus-side terminal portion 69 and the receiving portion 640 in a vertical direction. A tip end portion of the first apparatus-side positioning portion 82 on the +Y direction side is located on the +Y direction side of the apparatus-side terminal 692, the liquid supply portion 643, the liquid supply pressurizing portion 67, the first stirring pressurizing portion 70, and the second stirring pressurizing portion 72.

The second apparatus-side positioning portion 84 has the same shape as the first apparatus-side positioning portion 82. That is, the second apparatus-side positioning portion 84 is a member that protrudes from the apparatus-side front wall portion 62 toward the +Y direction. The second apparatus-side positioning portion 84 is a cylindrical rod-shaped member. The second apparatus-side positioning portion 84 is located on a vertical downward direction side of the receiving portion 640 and the liquid supply pressurizing portion 67. In addition, the second apparatus-side positioning portion 84 is located on a vertical downward direction side of the first apparatus-side positioning portion 82. A tip end portion of the second apparatus-side positioning portion 84 on the +Y direction side is located on the +Y direction side of the apparatus-side terminal 692 and the liquid supply portion 643.

When the cartridge 4 is mounted, the first apparatus-side positioning portion 82 and the second apparatus-side positioning portion 84 perform positioning of the cartridge 4. Specifically, the first apparatus-side positioning portion 82 and the second apparatus-side positioning portion 84 perform the positioning of the cartridge 4 in a direction intersecting the mounting direction of the cartridge 4.

The apparatus-side fixing structure 75 fixes the cartridge 4 to the cartridge mounting portion 6 in the mounted state. The apparatus-side fixing structure 75 has a locking pin 737 that engages with the cartridge 4 in the mounted state. Through the engagement, the apparatus-side fixing structure 75 fixes the cartridge 4 to the cartridge mounting portion 6. Here, the cartridge 4 receives a pressing force in the +Y direction from the surrounding cover 650 in the mounted state. The apparatus-side fixing structure 75 restricts the movement of the cartridge 4 in the +Y direction due to the pressing force by engaging with the cartridge 4. That is, the apparatus-side fixing structure 75 restricts the movement of the cartridge 4 in the +Y direction in the mounted state. The apparatus-side fixing structure 75 has a portion located on the +Y direction side of the apparatus-side front wall portion 62. At least a portion of the apparatus-side fixing structure 75 and at least a portion of the second apparatus-side positioning portion 84 are located at the same height.

The first stirring pressurizing portion 70 is a cylindrical member through which pressurized air for stirring the liquid accommodating portion of the cartridge 4K flows. The first stirring pressurizing portion 70 is coupled to a downstream end portion of the second fluid flow path 227K2 shown in FIG. 1. The first stirring pressurizing portion 70 is coupled to the cartridge 4 in the mounted state of the cartridge 4K. A cylindrical sealing member is disposed on an inner peripheral surface of the first stirring pressurizing portion 70. The sealing member is formed of rubber, for example.

The second stirring pressurizing portion 72 shown in FIG. 3 is a cylindrical member through which pressurized air for stirring the liquid accommodating portion of the cartridge 4K flows. The second stirring pressurizing portion 72 is coupled to a downstream end portion of the third fluid flow path 227K3 shown in FIG. 1. The second stirring pressurizing portion 72 is coupled to the cartridge 4 in the mounted state of the cartridge 4K. A cylindrical sealing member is disposed on an inner peripheral surface of the second stirring pressurizing portion 72. The sealing member is formed of rubber, for example.

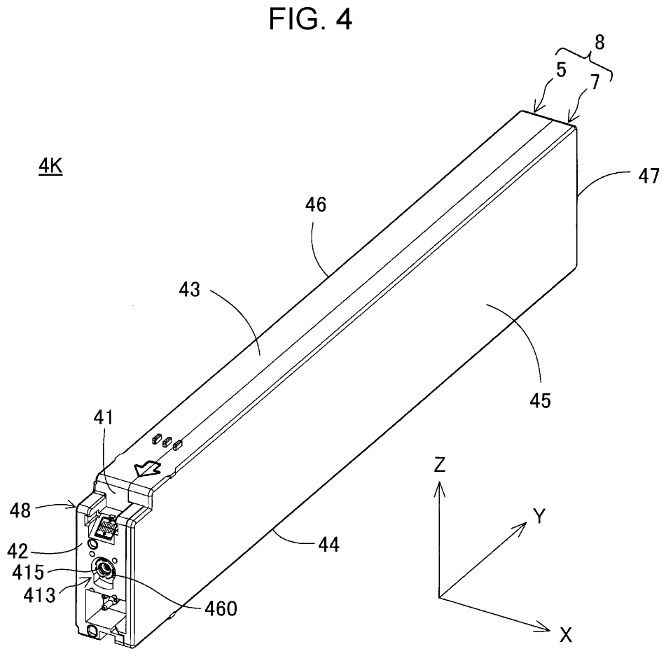

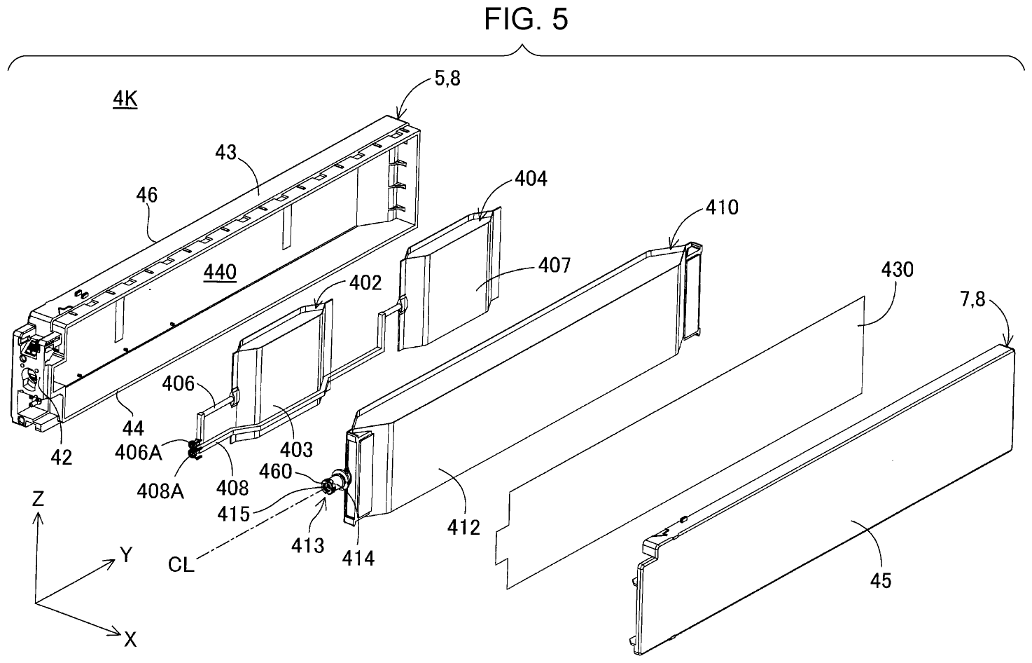

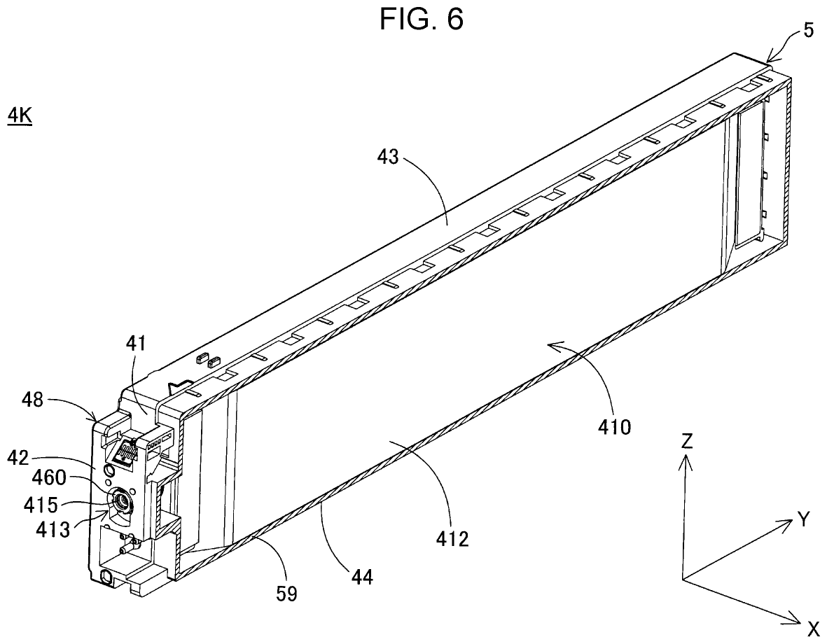

FIG. 4 is an external perspective view of the cartridge 4K. FIG. 5 is an exploded perspective view of the cartridge 4K. FIG. 6 is a diagram in which a second case 7 is removed from the cartridge 4K. FIGS. 4 to 6 show the X-axis, the Y-axis, and the Z-axis in the mounted state of the cartridge 4K. In addition, in the subsequent drawings, the X-axis, the Y-axis, and the Z-axis in the mounted state of the cartridge 4K are shown as necessary.

An outer shape of the cartridge 4K is a substantially rectangular parallelepiped shape as shown in FIG. 4. The cartridge 4K has dimensions that decrease in the Y direction, the Z direction, and the X direction in this order. The cartridge 4K includes a case member 8 forming an outer shell. The case member 8 is a housing formed by molding a synthetic resin such as polypropylene or polystyrene.

The cartridge 4 includes a front surface 42, a rear surface 47, a first side surface 43, a second side surface 44, a third side surface 45, and a fourth side surface 46. In addition, the cartridge 4 further has a second surface 41 located on the +Y direction side of the front surface 42. The second surface 41 and the front surface 42 are surfaces that face the −Y direction, which is the mounting direction.

Here, the first side surface 43 is also referred to as an upper surface 43, the second side surface 44 is also referred to as a bottom surface 44, the third side surface 45 is also referred to as a right side surface 45, and the fourth side surface 46 is also referred to as a left side surface 46. The front surface 42 and the rear surface 47 face each other in the Y direction, the front surface 42 is located on the −Y direction side, and the rear surface 47 is located on the +Y direction side. The first side surface 43 and the second side surface 44 intersect the front surface 42 and the rear surface 47, and face each other in the Z direction. The first side surface 43 is located on the +Z direction side, and the second side surface 44 is located on the −Z direction side. The third side surface 45 and the fourth side surface 46 intersect the front surface 42, the rear surface 47, the first side surface 43, and the second side surface 44, and face each other in the X direction. The third side surface 45 is located on the +X direction side, and the fourth side surface 46 is located on the −X direction side. In the present specification, the term “intersecting” between two elements means that the two elements are in any one of a state in which the two elements actually intersect each other, a state in which an extension portion of one element intersects the other element, and a state in which the extension portions of the two elements intersect each other.

The X direction is also referred to as a width direction of the cartridge 4K, the Y direction is also referred to as a length direction of the cartridge 4K, and the Z direction is also referred to as a height direction of the cartridge 4K.

It can also be said that the front surface 42 is formed as a protrusion portion 48 protruding from the second surface 41 to the −Y direction side. The shape of the front surface 42 is a substantially rectangular shape with the dimension in the Z direction being larger than the dimension in the X direction. The front surface 42 faces the apparatus-side front wall portion 62 shown in FIG. 3 in the mounted state.

As shown in FIG. 5, the cartridge 4K includes a first case 5, a second case 7, a liquid accommodating body 410, a sheet member 430, a first stirring member 402, and a second stirring member 404. The first case 5 and the second case 7 are formed by molding a synthetic resin. In the present embodiment, the case member 8 is formed of the first case 5 and the second case 7.

The first case 5 has a recessed shape with the +X direction side open. The first case 5 mainly forms the front surface 42, the first side surface 43, the second side surface 44, the fourth side surface 46, the rear surface 47, the second surface 41, and the protrusion portion 48.

The sheet member 430 is a thin film member. The sheet member 430 is airtightly joined to an end surface 59 that defines the opening of the first case 5 to seal the opening of the first case 5. For easy understanding, in FIG. 6, a single hatching is applied to the end surface 59. By airtightly joining the sheet member 430 to the end surface 59, an internal chamber 440 for accommodating the stirring portions 403 and 407, and the liquid accommodating portion 412, which will be described later, is partitioned and formed. The internal chamber 440 receives the supply of pressurized air flowing through the first fluid flow path 227K1. The internal chamber 440 presses the liquid accommodating portion 412 with the supplied pressurized air. Accordingly, the ink accommodated in the liquid accommodating portion 412 is pressurized. In the mounted state, the ink accommodated in the liquid accommodating portion 412 is pressurized, so that the ink in the liquid accommodating portion 412 is supplied to the printer 20 side. That is, the internal chamber 440 also functions as a pressurizing chamber for pressurizing the ink in the liquid accommodating portion 412 in order to supply the ink in the liquid accommodating portion 412 to the printer 20.

The second case 7 is attached to the first case 5 to cover the sheet member 430. The second case 7 mainly forms the right side surface 45. The first case 5 and the second case 7 protect the first stirring member 402, the second stirring member 404, the liquid accommodating body 410, and the sheet member 430, thereby suppressing damage. That is, the case member 8 accommodates the first stirring member 402, the second stirring member 404, the liquid accommodating body 410, and the sheet member 430.

The liquid accommodating body 410 includes the liquid accommodating portion 412 and a liquid flow-out portion 413. The liquid accommodating portion 412 accommodates ink. The liquid accommodating portion 412 is formed of a flexible member. The liquid accommodating portion 412 is a bag. As the filled ink is consumed, the volume of the liquid accommodating portion 412 decreases. The liquid accommodating portion 412 does not have to be a member that is entirely flexible, and may be formed of a member with flexibility at least in portion.

The liquid flow-out portion 413 causes the ink accommodated in the liquid accommodating portion 412 as a liquid supply source to flow to the printer 20. The liquid flow-out portion 413 has a supply port member 414. The supply port member 414 is a cylindrical member through which the ink can flow internally. The supply port member 414 has a central axis CL that extends parallel to the mounting direction, that is, in the Y direction. The supply port member 414 is coupled to an end portion of the liquid accommodating portion 412 on the +Y direction side. The supply port member 414 has a supply port 415 for supplying the ink as a liquid in the liquid accommodating portion 412 to an outside of the liquid accommodating portion 412. The supply port 415 communicates with the liquid accommodating portion 412. In the mounted state of the cartridge 4K, the supply port member 414 and the liquid supply portion 643 are coupled by inserting the tubular liquid supply portion 643 shown in FIG. 3 into the supply port member 414, more specifically, into the supply port 415. In the mounting process, the coupling between the supply port member 414 and the liquid supply portion 643 is started after the positioning engagement start time point. A valve mechanism is disposed in the supply port member 414. This valve mechanism is opened by the liquid supply portion 643 being coupled to the supply port member 414. The ink in the liquid accommodating portion 412 flows through the supply port member 414 and the liquid supply portion 643, and is supplied to the recording head 225 of the printer 20.

The first stirring member 402 shown in FIG. 5 has a first stirring portion 403 and a first fluid flow portion 406. The first stirring portion 403 is a bag with flexibility. One end portion of the first fluid flow portion 406 is coupled to the first stirring portion 403, and the other end portion 406A is coupled to a first stirring fluid receiving portion, which will be described later. The first fluid flow portion 406 causes the pressurized air supplied from the first stirring pressurizing portion 70 shown in FIG. 3 to flow to the first stirring portion 403.

The first stirring portion 403 receives the supply of the pressurized fluid supplied by the pressurizing pump 226 of the printer 20 shown in FIG. 1. The first stirring portion 403 presses the liquid accommodating portion 412 and stirs the ink accommodated in the liquid accommodating portion 412 by expanding the outer shape of the first stirring portion 403 due to the supplied pressurized fluid. As a result, the pigment particles that have settled in the −Z direction portion in the liquid accommodating portion 412 flow. By causing the pigment particles to flow, variations in the concentration distribution of the pigment particles in the ink in the liquid accommodating portion 412 can be reduced. The first stirring portion 403 is disposed to face a main surface of the liquid accommodating portion 412. In the present embodiment, the main surface of the liquid accommodating portion 412 is a surface of the liquid accommodating portion 412 on the −X direction side. The first stirring portion 403 to which the pressurized air is supplied increases in volume and expands in outer shape. When the supply of the pressurized air is stopped, the volume of the first stirring portion 403 decreases and the outer shape contracts. That is, the outer shape of the first stirring portion 403 is repeatedly expanded and contracted due to repeated supply and stop of the pressurized air. The outer shape of the first stirring portion 403 expands, so that the liquid accommodating portion 412 is pressed by the first stirring portion 403.

As shown in FIG. 5, the second stirring member 404 is disposed such that the second stirring portion 407 is located on the +Y direction side with respect to the first stirring portion 403. The second stirring member 404 has the second stirring portion 407 and a second fluid flow portion 408. The second stirring portion 407 has the same configuration as the first stirring portion 403. One end portion of the second fluid flow portion 408 is coupled to the second stirring portion 407, and the other end portion 408A is coupled to a second stirring fluid receiving portion, which will be described later. The second fluid flow portion 408 causes the pressurized air supplied from the second stirring pressurizing portion 72 shown in FIG. 3 to flow to the second stirring portion 407. Similar to the first stirring portion 403, the second stirring portion 407 stirs the ink accommodated in the liquid accommodating portion 412 by pressing the liquid accommodating portion 412. Similar to the first stirring portion 403, the outer shape of the second stirring portion 407 is repeatedly expanded and contracted due to repeated supply and stop of the pressurized air. The outer shape of the second stirring portion 407 expands, so that the liquid accommodating portion 412 is pressed by the second stirring portion 407.

The pressurized air is supplied to the first stirring portion 403 and the second stirring portion 407 alternately. That is, when the pressurized air is supplied to the first stirring portion 403, the supply of the pressurized air to the second stirring portion 407 is stopped. In addition, when the pressurized air is supplied to the second stirring portion 407, the supply of the pressurized air to the first stirring portion 403 is stopped.

In the above embodiment, the first stirring member 402 and the second stirring member 404 for stirring the ink in the liquid accommodating portion 412 are provided, but the number of stirring members is not limited to this. For example, there may be only the first stirring member 402, or there may be three or more stirring members.

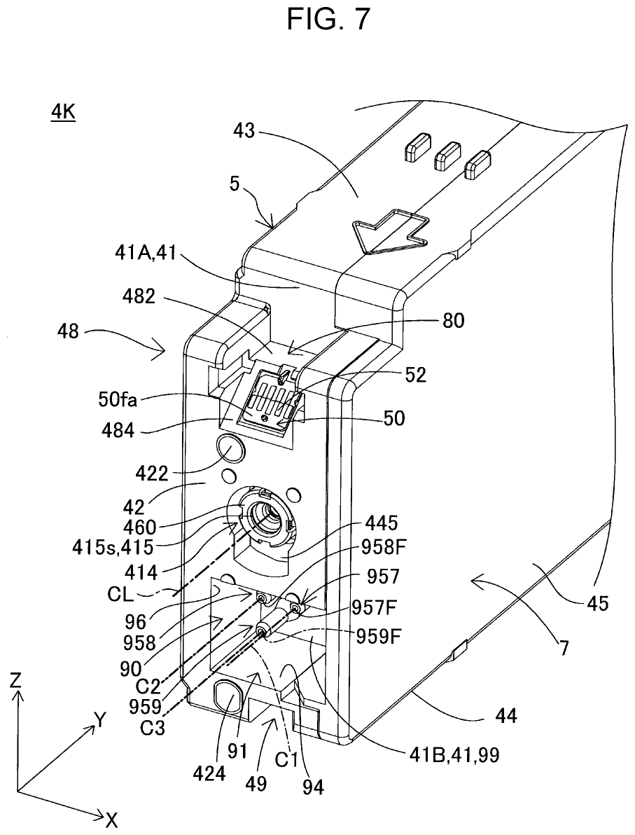

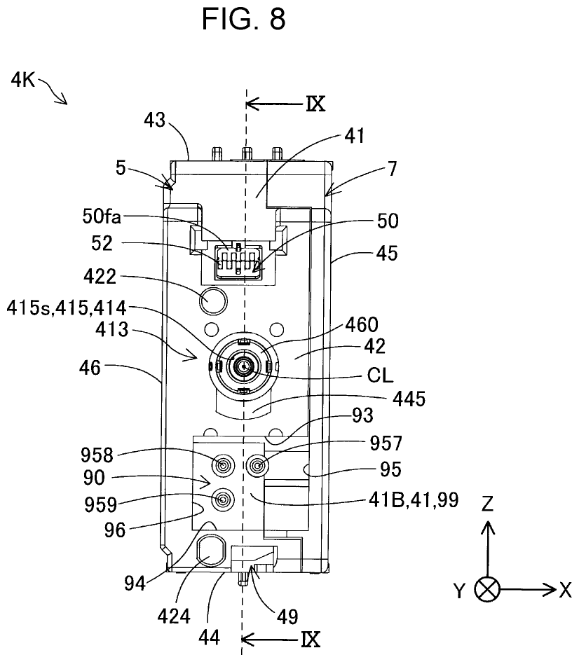

FIG. 7 is a first external perspective view of the front surface 42 side of the cartridge 4K. FIG. 8 is a front view of the cartridge 4K.

The cartridge 4K has a first positioning portion 422, a second positioning portion 424, and a fixing structure 49. The first positioning portion 422 and the second positioning portion 424 are provided on the front surface 42.

The first positioning portion 422 is a portion for engaging with the first apparatus-side positioning portion 82 shown in FIG. 3. The first positioning portion 422 is a through hole formed in the front surface 42. In the mounting process of mounting the cartridge 4K in the cartridge mounting portion 6, the first apparatus-side positioning portion 82 having a rod-shaped is inserted into the first positioning portion 422, which is a through hole, so that the first positioning portion 422 and the first apparatus-side positioning portion 82 are engaged with each other.

The second positioning portion 424 shown in FIGS. 7 and 8 is a portion for engaging with the second apparatus-side positioning portion 84 shown in FIG. 3. The second positioning portion 424 is a through hole formed in the front surface 42. The second positioning portion 424 is disposed on a vertical downward direction side of the first positioning portion 422 in the mounted state of the cartridge 4K. The first positioning portion 422 and the second positioning portion 424 are disposed at an interval along the Z direction in the mounted state. In the mounting process, the second apparatus-side positioning portion 84 having a rod-shaped is inserted into the second positioning portion 424, which is a through hole, so that the second positioning portion 424 and the second apparatus-side positioning portion 84 are engaged with each other.

In the mounting process of the cartridge 4K, +Y direction side end portions of the first apparatus-side positioning portion 82 and the second apparatus-side positioning portion 84 are inserted into the corresponding first positioning portion 422 and the second positioning portion 424, respectively. As described above, the time point when the insertion of the +Y direction side end portions of the first apparatus-side positioning portion 82 and the second apparatus-side positioning portion 84 is started is referred to as a positioning engagement start time point. Further, by pushing the cartridge 4K in the −Y direction, which is the mounting direction, the movement of the cartridge 4K in a direction intersecting the mounting direction is restricted by the first apparatus-side positioning portion 82 and the second apparatus-side positioning portion 84. That is, the cartridge 4K moves in the mounting direction with reference to the first apparatus-side positioning portion 82 and the second apparatus-side positioning portion 84.

As shown in FIG. 8, the first positioning portion 422 is a round hole, and the second positioning portion 424 is an elongated hole which is elongated in the Z direction. The first positioning portion 422 has a circular cross section that is perpendicular to a central axis CL direction of the supply port member 414. In the cross section perpendicular to the central axis CL direction, the first positioning portion 422 and the first apparatus-side positioning portion 82 have substantially corresponding outer shapes.

A cross section of the second positioning portion 424, which is perpendicular to the central axis CL direction (mounting direction of the cartridge 4K) of the supply port member 414, has an elongated hole shape that is elongated in the Z direction.

By forming the second positioning portion 424 as an elongated hole, positioning accuracy is maintained while allowing for easier dimensional tolerance or the like. Specifically, in a cross section perpendicular to the central axis CL direction, an outer shape of the second positioning portion 424 is slightly larger than an outer shape of the second apparatus-side positioning portion 84. As a result, when the second apparatus-side positioning portion 84 is inserted into the second positioning portion 424, a slight gap is generated between an inner peripheral surface of the second positioning portion 424 and an outer peripheral surface of the second apparatus-side positioning portion 84. That is, in the mounting process, the accuracy of the positioning of the cartridge 4K is ensured by the first positioning portion 422, and the relative positional deviation between the second positioning portion 424 and the second apparatus-side positioning portion 84 due to the dimensional tolerance or the like is absorbed by the second positioning portion 424.

The fixing structure 49 shown in FIGS. 7 and 8 is a portion for engaging with the apparatus-side fixing structure 75. The fixing structure 49 is a groove formed in the second side surface 44. When the cartridge 4K is attached to or detached from the cartridge mounting portion 6, the locking pin 737 shown in FIG. 3 moves in the groove-shaped fixing structure 49. Further, in the mounted state of the cartridge 4K, the locking pin 737 is engaged with the groove-shaped fixing structure 49. In the mounted state of the cartridge 4K, the engagement between the locking pin 737 and the fixing structure 49 is released by pressing the cartridge 4K to a −Y direction side, and the cartridge 4K can be removed from the cartridge mounting portion 6.

As shown in FIGS. 7 and 8, the cartridge 4K further includes a recessed portion 90, a liquid flow-out fluid receiving portion 957, a first stirring fluid receiving portion 958, a second stirring fluid receiving portion 959, a circuit substrate 50, and a flow port disposition hole 445. Here, of the second surface 41, a surface coupled to the first side surface 43 is also referred to as a second upper surface 41A, and a surface coupled to the second side surface 44 is also referred to as a second lower surface 41B. The second lower surface 41B forms a bottom surface of a recessed portion 90, which will be described later. The second lower surface 41B is also referred to as a recessed portion bottom surface 99.

The circuit substrate 50 is disposed at a terminal disposition portion 80 which is a surface coupling the front surface 42 and the second upper surface 41A. The terminal disposition portion 80 has an inclined surface 484 that is inclined with respect to the mounting direction, and a coupling surface 482 that couples the inclined surface 484 and the second upper surface 41A. The inclined surface 484 is inclined to face a direction including a +Z direction component and a −Y direction component. The coupling surface 482 is a horizontal surface in the mounted state. The circuit substrate 50 is disposed on the inclined surface 484. The circuit substrate 50 is disposed on a vertical upper direction side of the first positioning portion 422. A cartridge-side terminal 52 that comes into contact with the apparatus-side terminal 692 of the apparatus-side terminal portion 69 shown in FIG. 3 is disposed on a surface 50fa of the circuit substrate 50. As shown in FIGS. 7 and 8, the cartridge-side terminal 52 is provided on the surface 50fa corresponding to the plurality of apparatus-side terminals 692. In the present embodiment, the number of cartridge-side terminals 52 is nine. In the mounting process, the contact between the apparatus-side terminal 692 and the cartridge-side terminal 52 is started after the positioning engagement start time point.

A storage apparatus is provided on a rear surface of the circuit substrate 50. The storage apparatus stores various information such as information related to the ink of the cartridge 4K. The information related to the ink is, for example, information indicating the remaining amount of the ink or the color of the ink. When the cartridge-side terminal 52 comes into contact with the apparatus-side terminal 692 of the printer 20, for example, the data signal is transmitted and received between the storage apparatus and the control portion 230 of the printer 20.

The flow port disposition hole 445 is formed in the front surface 42. Specifically, in the mounted state of the cartridge 4K, the flow port disposition hole 445 is located between the first positioning portion 422 and the second positioning portion 424 in the vertical direction. The flow port disposition hole 445 receives the supply port member 414. At least the tip end portion of the liquid flow-out portion 413 is disposed in the flow port disposition hole 445. More specifically, at least the opening surface 415s of the supply port 415 and a covering member 460, which will be described later, are disposed in the flow port disposition hole 445.

The recessed portion 90 is formed in the front surface 42. The recessed portion 90 is located between the first positioning portion 422 and the second positioning portion 424 in the mounted state of the cartridge 4K. The recessed portion 90 is open in the −Y direction, which is the mounting direction. The recessed portion 90 has a recessed portion bottom surface 99, an opening portion 91, a first recessed portion side surface 93, a second recessed portion side surface 94, a third recessed portion side surface 95, and a fourth recessed portion side surface 96. The recessed portion 90 is defined by the recessed portion bottom surface 99, the opening portion 91, the first recessed portion side surface 93, the second recessed portion side surface 94, the third recessed portion side surface 95, and the fourth recessed portion side surface 96.

As shown in FIG. 7, the recessed portion bottom surface 99 and the opening portion 91 face each other in the Y direction. The recessed portion bottom surface 99 is located on the +Y direction side, which is a removal direction, and the opening portion 91 is located on the −Y direction side, which is the mounting direction. As shown in FIG. 8, the first recessed portion side surface 93 and the second recessed portion side surface 94 face each other in the Z direction. The first recessed portion side surface 93 is located on the +Z direction side, and the second recessed portion side surface 94 is located on the −Z direction side. As shown in FIG. 8, the third recessed portion side surface 95 and the fourth recessed portion side surface 96 face each other in the X direction, which is a width direction of the cartridge 4K. The third recessed portion side surface 95 is located on the +X direction side, and the fourth recessed portion side surface 96 is located on the −X direction side.

An outer shape of the recessed portion bottom surface 99 is substantially rectangular. The opening portion 91 is located on the front surface 42, and in the mounting process, the liquid supply pressurizing portion 67, the first stirring pressurizing portion 70, and the second stirring pressurizing portion 72, which are portions of the pressurizing mechanism 280 shown in FIG. 3, respectively pass through the opening portion 91. The first recessed portion side surface 93, the second recessed portion side surface 94, the third recessed portion side surface 95, and the fourth recessed portion side surface 96 are erected from each side forming the outer shape of the recessed portion bottom surface 99 toward the mounting direction side.

As shown in FIGS. 7 and 8, the recessed portion 90 is formed by the first case 5 and the second case 7. Specifically, the recessed portion bottom surface 99, the fourth recessed portion side surface 96, and the first recessed portion side surface 93 are formed by the first case 5. The second recessed portion side surface 94 and the opening portion 91 are formed by the first case 5 and the second case 7. The third recessed portion side surface 95 is formed by the second case 7.

As shown in FIG. 8, the liquid flow-out fluid receiving portion 957, the first stirring fluid receiving portion 958, and the second stirring fluid receiving portion 959 are disposed inside the recessed portion 90.

The liquid flow-out fluid receiving portion 957 shown in FIG. 7 is a tubular member. The liquid flow-out fluid receiving portion 957 has a central axis C1 parallel to the central axis CL. The liquid flow-out fluid receiving portion 957 protrudes from the recessed portion bottom surface 99 in the mounting direction. A base end portion, which is a +Y direction side portion of the liquid flow-out fluid receiving portion 957, is coupled to the recessed portion bottom surface 99. A flow path formed inside the liquid flow-out fluid receiving portion 957 communicates the outside of the cartridge 4K with the internal chamber 440 shown in FIG. 5. A tip end portion 957F of the liquid flow-out fluid receiving portion 957 on the −Y direction side is inserted into the liquid supply pressurizing portion 67 in the mounted state, and is thus coupled to the liquid supply pressurizing portion 67. Specifically, the tip end portion 957F is inserted into the inside of the cylindrical sealing member provided in the liquid supply pressurizing portion 67, and is thus airtightly coupled to the liquid supply pressurizing portion 67. The tip end portion 957F receives the pressurized fluid supplied through the liquid supply pressurizing portion 67. That is, the pressurized fluid supplied from the printer 20 reaches the tip end portion 957F. The tip end portion 957F is open, and the pressurized fluid that has passed through the opening flows to the internal chamber 440 through the internal flow path of the liquid flow-out fluid receiving portion 957.

As shown in FIG. 7, the first stirring fluid receiving portion 958 is a tubular member. The first stirring fluid receiving portion 958 has a central axis C2 parallel to the central axis CL. The first stirring fluid receiving portion 958 protrudes from the recessed portion bottom surface 99 in the mounting direction. A base end portion, which is a +Y direction side portion of the first stirring fluid receiving portion 958, is coupled to the recessed portion bottom surface 99. A flow path formed inside the first stirring fluid receiving portion 958 communicates the outside of the cartridge 4K with the first fluid flow portion 406. The tip end portion 958F of the first stirring fluid receiving portion 958 on the −Y direction side is inserted into the first stirring pressurizing portion 70 shown in FIG. 3 in the mounted state, and is thus coupled to the first stirring pressurizing portion 70. Specifically, the tip end portion 958F is inserted into the inside of the cylindrical sealing member provided in the first stirring fluid receiving portion 958, and is thus airtightly coupled to the first stirring fluid receiving portion 958. The tip end portion 958F receives the pressurized fluid supplied through the first stirring pressurizing portion 70. That is, the pressurized fluid supplied from the printer 20 reaches the tip end portion 958F. The tip end portion 958F is open, and the pressurized fluid that has passed through the opening flows to the first fluid flow portion 406 through the internal flow path of the first stirring pressurizing portion 70. Pressurized air is introduced into the first stirring portion 403 through the first fluid flow portion 406.

As shown in FIG. 7, the second stirring fluid receiving portion 959 is a tubular member. The second stirring fluid receiving portion 959 has a central axis C3 parallel to the central axis CL. The second stirring fluid receiving portion 959 protrudes from the recessed portion bottom surface 99 in the mounting direction. A base end portion, which is a +Y direction side portion of the second stirring fluid receiving portion 959, is coupled to the recessed portion bottom surface 99. A flow path formed inside the second stirring fluid receiving portion 959 communicates the outside of the cartridge 4K with the second fluid flow portion 408. The tip end portion 959F of the second stirring fluid receiving portion 959 on the −Y direction side is inserted into the second stirring pressurizing portion 72 shown in FIG. 3 in the mounted state, and is thus coupled to the second stirring pressurizing portion 72. Specifically, the tip end portion 959F is inserted into the inside of the cylindrical sealing member provided in the second stirring fluid receiving portion 959, and thus the tip end portion 959F is airtightly coupled to the second stirring fluid receiving portion 959. The tip end portion 959F receives the pressurized fluid supplied through the second stirring pressurizing portion 72. That is, the pressurized fluid supplied from the printer 20 reaches the tip end portion 959F. The tip end portion 959F is open, and the pressurized fluid that has passed through the opening flows to the second fluid flow portion 408 through the internal flow path of the second stirring pressurizing portion 72. Pressurized air is introduced into the second stirring portion 407 through the second fluid flow portion 408.

The cartridges 4C, 4M, and 4Y are different from the cartridge 4K in that the cartridges 4C, 4M, and 4Y do not have the first stirring fluid receiving portion 958 and the second stirring fluid receiving portion 959 shown in FIG. 7, do not have the first stirring member 402 and the second stirring member 404 shown in FIG. 5, and have a small amount of ink accommodated in the liquid accommodating portion 412. Other configurations of the cartridges 4C, 4M, 4Y and the cartridge 4K are the same. For example, the cartridges 4C, 4M, and 4Y have the recessed portion 90 on the front surface 42. The recessed portion 90 is open in the mounting direction. The liquid flow-out fluid receiving portion 957 is disposed inside the recessed portion 90.

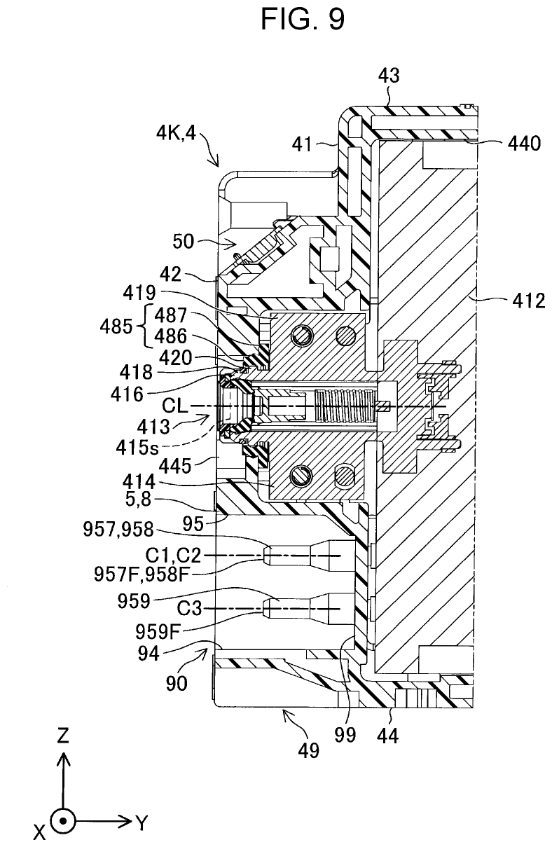

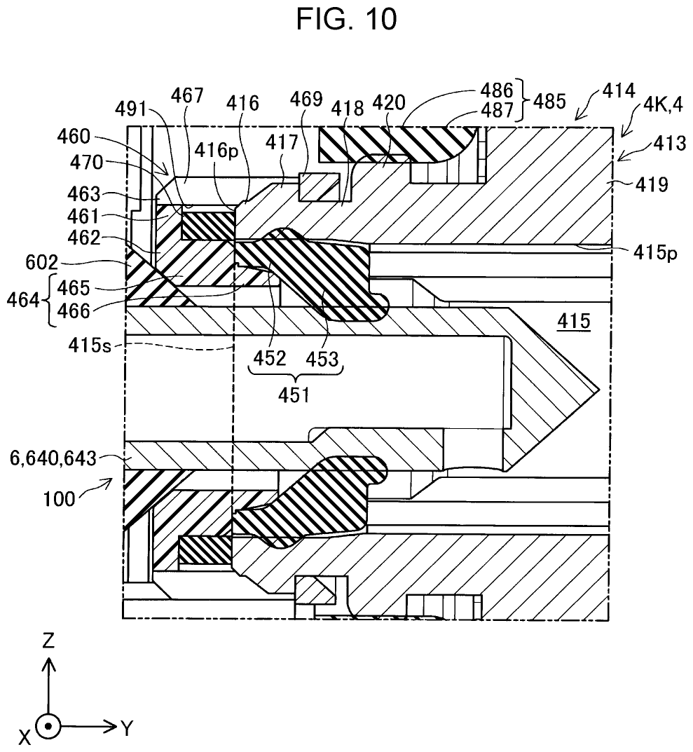

FIG. 9 is a cross-sectional view taken along line IX-IX in FIG. 8. FIG. 10 is a cross-sectional view of a vicinity of the liquid flow-out portion 413 shown in FIG. 9. FIG. 9 shows a state of the cartridge 4, specifically, the cartridge 4K in a state in which the liquid supply portion 643 is not inserted into the supply port 415. FIG. 10 shows a state of the cartridge 4, specifically, the cartridge 4K in a state in which the liquid supply portion 643 is inserted into the supply port 415. That is, FIG. 10 shows a state of the cartridge 4K in the mounted state. In addition, FIG. 10 shows a portion of the receiving portion 640 of the printer 20.

As shown in FIG. 10, the liquid flow-out portion 413 includes a first sealing member 451, a covering member 460, and a second sealing member 470 in addition to the supply port member 414. Further, the liquid flow-out portion 413 includes a pressurized fluid sealing portion 485.

As shown in FIGS. 9 and 10, in the present embodiment, the supply port member 414 has a small diameter portion 418 and a large diameter portion 419. As shown in FIG. 9, the small diameter portion 418 and the large diameter portion 419 are disposed on the −Y direction side of the liquid accommodating portion 412. As shown in FIGS. 9 and 10, the small diameter portion 418 is disposed on the −Y direction side of the large diameter portion 419. That is, the large diameter portion 419 is located between the small diameter portion 418 and the liquid accommodating portion 412 in the Y direction. An outer diameter of the small diameter portion 418 is smaller than an outer diameter of the large diameter portion 419. The small diameter portion 418 includes an outer end portion 416 of the supply port member 414. The outer end portion 416 is an end portion of the supply port member 414 on a side opposite to the liquid accommodating portion 412. In the present embodiment, the outer end portion 416 is an end portion of the supply port member 414 on the −Y direction side.

As shown in FIG. 10, the first sealing member 451 is provided on an inner peripheral surface 415p of the supply port 415. The first sealing member 451 has an annular shape. In the present embodiment, the first sealing member 451 has a hollow substantially cylindrical shape. The first sealing member 451 is made of, for example, an elastic material such as rubber or a thermoplastic elastomer. The first sealing member 451 is used to liquid-tightly couple the liquid flow-out portion 413 and the liquid supply portion 643. More specifically, the first sealing member 451 seals between an outer peripheral surface of the liquid supply portion 643 inserted into the supply port 415 and the inner peripheral surface 415p of the supply port 415.

In the present embodiment, the first sealing member 451 has a thin portion 452 and a thick portion 453. A thickness of the thin portion 452 in a radial direction is smaller than a thickness of the thick portion 453 in the radial direction. An inner diameter of the thin portion 452 is larger than an inner diameter of the thick portion 453. As will be described later, the thin portion 452 is held by the covering member 460 between the covering member 460 and the inner peripheral surface 415p of the supply port 415. An outer peripheral surface of the liquid supply portion 643 inserted into the supply port 415 comes into contact with an inner peripheral surface of the thick portion 453. As a result, the first sealing member 451 seals between the outer peripheral surface of the liquid supply portion 643 and the inner peripheral surface 415p of the supply port 415.

The covering member 460 covers a portion of the opening surface 415s of the supply port 415 from the outside of the supply port 415. In the present embodiment, the covering member 460 is configured as a cap. The covering member 460 as a cap is made of a resin material, for example. The covering member 460 has a second engaging portion 469. The second engaging portion 469 engages with a first engaging portion 417 provided at the outer end portion 416 of the supply port member 414 in the orthogonal direction. The orthogonal direction is a direction orthogonal to the opening surface 415s. In the present embodiment, a plane direction of the opening surface 415s is the XZ direction, and the orthogonal direction is the Y direction. The covering member 460 is fixed to the supply port member 414 by the engagement of the first engaging portion 417 and the second engaging portion 469. In the present embodiment, the second engaging portion 469 is engaged with the first engaging portion 417 by a snap-fit using the elasticity of the second engaging portion 469.

More specifically, the covering member 460 has a bottom portion 461, an inner wall portion 464, and an outer wall portion 467. The bottom portion 461 has a substantially annular shape. The bottom portion 461 is disposed on the −Y direction side of the outer end portion 416. A surface of the bottom portion 461 on the +Y direction side faces an outer end surface 416p on the −Y direction side of the outer end portion 416 in the Y direction. In the present embodiment, the bottom portion 461 is disposed to be separated from the outer end surface 416p in the Y direction. The bottom portion 461 has an inner portion 462 that overlaps the opening surface 415s when viewed in the Y direction, and an outer portion 463 that is located outside the opening surface 415s. More specifically, the outer portion 463 is a portion located outside the outer end surface 416p when viewed in the Y direction.

The inner wall portion 464 is erected from the inner portion 462 in the +Y direction. The inner wall portion 464 has a substantially annular shape. The inner wall portion 464 has a first inner wall portion 465 and a second inner wall portion 466 in the Y direction. The first inner wall portion 465 is located between the bottom portion 461 and the second inner wall portion 466 in the Y direction. The first inner wall portion 465 is disposed outside the supply port 415, that is, on the −Y direction side of the opening surface 415s. The second inner wall portion 466 is disposed inside the supply port 415. A thickness of the second inner wall portion 466 in the Z direction is smaller than a thickness of the first inner wall portion 465 in the Z direction. The second inner wall portion 466 is disposed to be separated from the inner peripheral surface 415p in the radial direction of the supply port 415. The thin portion 452 of the first sealing member 451 is disposed between the second inner wall portion 466 and the inner peripheral surface 415p to be in contact with the second inner wall portion 466 and the inner peripheral surface 415p. More specifically, at least a portion of the thin portion 452 is elastically deformed by the second inner wall portion 466 and is pressed against the inner peripheral surface 415p from the outside to the inside in the radial direction of the supply port 415.

The outer wall portion 467 is erected from the outer portion 463 in the +Y direction. The outer wall portion 467 has a substantially annular shape. In the radial direction of the supply port 415, the outer wall portion 467 is located outside the inner wall portion 464. The second engaging portion 469 described above is provided at the end portion of the outer wall portion 467 on the +Y direction side. The first engaging portion 417 of the supply port member 414 is configured as a flange-shaped portion having an outer shape larger than the other portion of the outer end portion 416 among the outer end portion 416. The first engaging portion 417 and the second engaging portion 469 engage with each other by engaging a surface of the first engaging portion 417 on the +Y direction side and a surface of the second engaging portion 469 on the −Y direction side.

The second sealing member 470 is made of, for example, an elastic material such as rubber or a thermoplastic elastomer. In the present embodiment, the second sealing member 470 has a substantially annular shape. The second sealing member 470 seals a leakage path of the ink as liquid. The leakage path is a path through which the ink leaks from the cartridge 4. The leakage path is located outside the supply port 415. The leakage path is a gap between elements included in the cartridge 4. In the present embodiment, the leakage path sealed by the second sealing member 470 is a first gap 491. The first gap 491 is a gap between the supply port member 414 and the covering member 460. More specifically, in the present embodiment, the first gap 491 sealed by the second sealing member 470 is a gap between the bottom portion 461, the inner wall portion 464, the outer wall portion 467, and the outer end surface 416p.

In the present embodiment, the second sealing member 470 is disposed between the supply port member 414 and the covering member 460 to seal the first gap 491 as a leakage path. As a result, the second sealing member 470 is disposed between the outer end surface 416p of the outer end portion 416 and the bottom portion 461 of the covering member 460 in the Y direction. The second sealing member 470 is disposed to be in contact with a surface of the bottom portion 461 on the +Y direction side and the outer end surface 416p in the Y direction. More specifically, as described above, the second sealing member 470 is pressed in the +Y direction with respect to the outer end surface 416p while being elastically deformed by the bottom portion 461 by the engagement of the first engaging portion 417 and the second engaging portion 469 in the Y direction.

As shown in FIG. 9, the pressurized fluid sealing portion 485 is disposed between the supply port member 414 and the case member 8. The pressurized fluid sealing portion 485 is provided to suppress the leakage of the pressurized air supplied to the internal chamber 440. The pressurized fluid sealing portion 485 airtightly seals between the supply port member 414 and the case member 8.

In the present embodiment, the pressurized fluid sealing portion 485 has a substantially annular shape. The pressurized fluid sealing portion 485 is disposed so that an axial direction thereof is along the Y direction. In the present embodiment, the pressurized fluid sealing portion 485 is disposed on the +Y direction side of the opening surface 415s. The pressurized fluid sealing portion 485 is disposed to surround the periphery of the small diameter portion 418 in the radial direction of the supply port member 414. The pressurized fluid sealing portion 485 has a leading end portion 486 and a trailing end portion 487. The trailing end portion 487 has a flange-shaped portion having an outer diameter larger than an outer diameter of the leading end portion 486. The flange-shaped portion of the trailing end portion 487 is disposed in the gap in the Y direction formed between the case member 8 and the large diameter portion 419. The leading end portion 486 is disposed to extend the gap between the case member 8 and the small diameter portion 418 in the Y direction. The leading end portion 486 is pressed against the case member 8 from the inside to the outside in the radial direction by a pressing portion 420 provided in the small diameter portion 418. The pressing portion 420 is a portion of the small diameter portion 418 that protrudes outward in the radial direction compared to other portions.

As shown in FIG. 10, the configuration including the cartridge 4 and the cartridge mounting portion 6 is also referred to as a liquid supply system 100. The liquid supply system 100 supplies the liquid to the recording head 225 shown in FIG. 1. As shown in FIG. 10, the receiving portion 640 of the cartridge mounting portion 6 is provided with a third sealing member 602. That is, the liquid supply system 100 in the present embodiment includes the third sealing member 602. The third sealing member 602 seals between the receiving portion 640 and the covering member 460 in the mounted state. More specifically, in the present embodiment, the third sealing member 602 is provided at the outer peripheral portion of a tubular liquid supply portion 643. The third sealing member 602 seals between the outer peripheral portion of the liquid supply portion 643 and the covering member 460.

According to the cartridge 4 in the present embodiment described above, the second sealing member 470 that seals the leakage path of the liquid outside the supply port 415 is provided in addition to the first sealing member 451 provided on the inner peripheral surface 415p of the supply port 415. Therefore, even when the liquid leaks from the inside to the outside of the supply port 415 through the gap between the first sealing member 451 and the inner peripheral surface 415p, the second sealing member 470 can suppress the leakage of the liquid to the outside of the cartridge 4 through the leakage path. In this way, according to the present embodiment, the leakage of the liquid to the outside of the cartridge 4 can be more reliably suppressed.

In addition, in the present embodiment, the leakage path is the first gap 491 between the supply port member 414 and the covering member 460, and the second sealing member 470 is disposed between the supply port member 414 and the covering member 460. Therefore, even when the liquid leaks from the gap between the first sealing member 451 and the inner peripheral surface 415p, the second sealing member 470 can retain the leaked liquid at a position relatively close to the opening surface 415s of the supply port 415.

In addition, in the present embodiment, the second sealing member 470 is disposed between the outer end portion 416 of the supply port member 414 and the covering member 460 in the Y direction, which is the orthogonal direction. More specifically, the second sealing member 470 is disposed between the outer end surface 416p of the outer end portion 416 and the bottom portion 461 of the covering member 460. Therefore, for example, the liquid leaking from the gap between the first sealing member 451 and the inner peripheral surface 415p can be further retained at a position closer to the opening surface 415s of the supply port 415, as compared with a form in which the second sealing member 470 is disposed between the inner wall portion 464 of the covering member 460 and the outer peripheral surface of the supply port member 414.

In addition, in the present embodiment, the covering member 460 is configured as a cap having the second engaging portion 469. The second engaging portion 469 engages with a first engaging portion 417 provided at the outer end portion 416 of the supply port member 414 in the Y direction. The covering member 460 is fixed to the supply port member 414 by the engagement of the first engaging portion 417 and the second engaging portion 469. According to this embodiment, the second sealing member 470 can be more firmly pinched between the outer end portion 416 of the supply port member 414 and the bottom portion 461 of the covering member 460. For this reason, the first gap 491 as the leakage path can be more effectively sealed by the second sealing member 470.

In addition, in the present embodiment, the receiving portion 640 of the liquid supply system 100 includes the third sealing member 602. According to the liquid supply system 100 of this embodiment, even when the liquid leaks from the supply port 415, the liquid can be retained between the receiving portion 640 and the covering member 460 by the third sealing member 602. Therefore, the leakage of the liquid to the outside of the cartridge 4 can be further reliably suppressed.

In another embodiment, the second sealing member 470 may be configured integrally with the covering member 460. More specifically, the second sealing member 470 may be formed integrally with the covering member 460 by, for example, two-color molding. Thus, the second sealing member 470 can be provided while suppressing an increase in the number of components.

In addition, the second sealing member 470 may be configured integrally with the supply port member 414. More specifically, the second sealing member 470 may be formed integrally with the supply port member 414 by, for example, two-color molding. Thus, the second sealing member 470 can be provided while suppressing an increase in the number of components.

### B. Second Embodiment

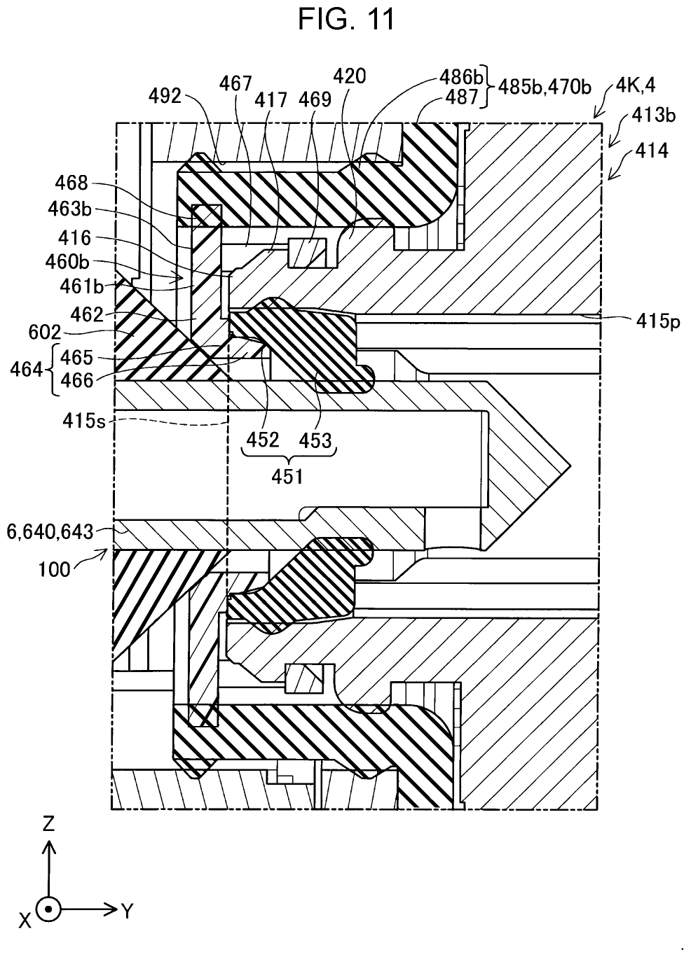

FIG. 11 is a cross-sectional view of the vicinity of a liquid flow-out portion 413b according to a second embodiment. In the present embodiment, unlike the first embodiment, a second sealing member 470b seals a second gap 492 as a leakage path. The second gap 492 is a gap between the case member 8 and a covering member 460b. In addition, the second sealing member 470b is disposed between the case member 8 and the covering member 460b. Among the liquid ejecting system 1, the cartridge 4, and the liquid supply system 100 according to the present embodiment, points not particularly described are the same as those of the first embodiment.

In the present embodiment, a pressurized fluid sealing portion 485b functions as the second sealing member 470b. A leading end portion 486b of the pressurized fluid sealing portion 485b protrudes in the −Y direction side from the opening surface 415s. More specifically, the leading end portion 486b protrudes in the −Y direction from the covering member 460b. As a result, the pressurized fluid sealing portion 485b is disposed to surround the periphery of the small diameter portion 418 and the covering member 460b in the radial direction of the supply port member 414. In addition, in the present embodiment, an outer portion 463b of a bottom portion 461b of the covering member 460b has an outer protrusion portion 468 protruding in the radial direction toward the leading end portion 486b. The outer protrusion portion 468 comes in contact with the leading end portion 486b to press the leading end portion 486b from the inside to the outside in the radial direction against the case member 8. In this manner, the leading end portion 486b seals the second gap 492, and thus the pressurized fluid sealing portion 485b functions as the second sealing member 470b.

According to the cartridge 4 in the present embodiment described above, the leakage path is the second gap 492 between the case member 8 and the covering member 460b, and the second sealing member 470b is disposed between the case member 8 and the covering member 460b. Therefore, for example, as compared with a form in which the second sealing member 470 is provided between the supply port member 414 and the covering member 460 as in the first embodiment, the vicinity of the opening surface 415s of the supply port 415 in the cartridge 4 can be configured to be more space-saving.

In another embodiment, the second sealing member 470b may be configured integrally with, for example, the covering member 460b, or may be configured integrally with the supply port member 414.

### C. Other Embodiments

C-1. In the first embodiment described above, the second sealing member 470 is disposed between the outer end portion 416 of the supply port member 414 and the covering member 460 in the orthogonal direction, but the second sealing member 470 may not be disposed in this manner. For example, the second sealing member 470 may be disposed between the outer wall portion 467 of the covering member 460 and an outer peripheral surface of the outer end portion 416 of the supply port member 414, and may seal the gap between the outer wall portion 467 and the outer peripheral surface of the outer end portion 416 of the supply port member 414. That is, the first gap sealed by the second sealing member 470 may be a gap between the outer wall portion 467 and the outer peripheral surface of the outer end portion 416 of the supply port member 414, for example.

C-2. In each of the embodiments described above, the covering member 460 is configured as a cap, but may not be configured as a cap. For example, the covering member 460 may be configured as a film covering a portion of the opening surface 415s.

C-3. In each of the embodiments described above, the second sealing member 470 may seal various leakage paths, not limited to the first gap 491 and the second gap 492.

C-4. In each of the embodiments described above, the liquid supply system 100 may not include the third sealing member 602.

C-5. The present disclosure is not limited to the ink jet printer and the ink cartridge thereof, and can also be applied to any printing apparatus that ejects liquid other than ink and the cartridge thereof. For example, the present disclosure can be applied to various printing apparatuses and cartridges thereof as follows.
1. An image recording apparatus such as a facsimile apparatus
2. A printing apparatus that ejects a coloring material used for manufacturing a color filter for an image display apparatus such as a liquid crystal display
3. A printing apparatus that ejects an electrode material used for forming an electrode of an organic electro luminescence (EL) display, a field emission display (FED), or the like
4. A printing apparatus that ejects a liquid containing a bioorganic substance used for manufacturing a biochip.
5. A sample printing apparatus as a precision pipette
6. A printing apparatus for lubricant
7. A printing apparatus for a resin liquid
8. A printing apparatus that ejects lubricant into a precision machine such as a timepiece or a camera in a pinpoint manner
9. A printing apparatus that ejects a transparent resin liquid such as an ultraviolet curable resin liquid onto a substrate for forming a micro hemispherical lens (optical lens) or the like used for an optical communication element or the like
10. A printing apparatus that ejects an acidic or alkaline etching solution to etch a substrate or the like
11. A printing apparatus including a liquid ejecting head for discharging any other minute amount of droplets

The term “droplet” refers to a state of a liquid discharged from the printing apparatus, and includes granular one, tear-like one, or thread-like one as well as one having a tail. In addition, the “liquid” referred here need only be any material that can be ejected by a printing apparatus. For example, the “liquid” need only be a material in a state at the time when a substance is in a liquid phase, and the “liquid” includes a liquid state material with high or low viscosity, sol, gel water, and other liquid state materials such as an inorganic solvent, an organic solvent, a solution, liquid resin, and liquid metal. In addition, the “liquid” includes not only a liquid as a state of a substance but also a liquid in which particles of a functional material made of a solid substance, such as a pigment or a metal particle, are dissolved, dispersed, or mixed in a solvent. In addition, a typical example of a liquid includes ink as in the above embodiment or a liquid crystal. Here, the ink includes various liquid compositions such as general water-based ink and oil-based ink as well as gel ink and hot-melt ink.

### D. Other Aspects

The present disclosure is not limited to the above-described embodiments, and can be realized in various aspects without departing from the gist thereof. For example, the present disclosure can also be realized in the following aspects. Technical features in the above embodiments corresponding to technical features in respective aspects described below can be appropriately replaced or combined in order to solve some or all of the problems of the present disclosure, or achieve some or all of the effects of the present disclosure. In addition, when the technical features are not described as essential in the present specification, the technical features can be appropriately deleted.

1. According to a first aspect of the present disclosure, there is provided a cartridge. The cartridge includes a liquid accommodating portion configured to accommodate liquid, a supply port member having a supply port that communicates with the liquid accommodating portion and supplies the liquid to an outside of the liquid accommodating portion, a first sealing member provided on an inner peripheral surface of the supply port, a covering member configured to cover a portion of an opening surface of the supply port from an outside of the supply port, and a second sealing member configured to seal a leakage path of the liquid outside the supply port, the leakage path being a gap between elements included in the cartridge.

According to this aspect, in addition to the first sealing member provided in the supply port, the second sealing member that seals the leakage path on the outside of the supply port is provided, so that the leakage of the liquid to the outside of the cartridge can be more reliably suppressed.

2. In the aspect described above, the leakage path may be the gap between the supply port member and the covering member, and the second sealing member may be disposed between the supply port member and the covering member. According to this aspect, even when the liquid leaks from between the first sealing member and the inner peripheral surface, the second sealing member can retain the leaked liquid at a position relatively close to the opening surface of the supply port.

3. In the aspect described above, the second sealing member may be disposed between an end portion of the supply port member opposite to the liquid accommodating portion and the covering member in an orthogonal direction orthogonal to the opening surface. According to this aspect, the liquid leaked from between the first sealing member and the inner peripheral surface can be retained at a position closer to the opening surface.

4. In the aspect described above, the covering member may be configured as a cap having a second engaging portion that engages with a first engaging portion provided at the end portion in the orthogonal direction, and may be fixed to the supply port member by the engagement of the first engaging portion and the second engaging portion. According to this aspect, the second sealing member can be more firmly pinched between the end portion of the supply port member and the covering member. For this reason, the second sealing member can more effectively seal between the supply port member and the covering member.

5. In the aspect described above, the cartridge may further include a case member configured to accommodate the supply port member, the leakage path may be the gap between the case member and the covering member, and the second sealing member may be disposed between the case member and the covering member. According to this aspect, for example, as compared with a form in which the second sealing member is provided between the supply port member and the covering member, the vicinity of the opening surface of the supply port in the cartridge can be configured to be more space-saving.

6. In the aspect described above, the second sealing member may be formed integrally with the covering member. According to this aspect, the second sealing member can be provided while suppressing an increase in the number of components.

7. In the aspect described above, the second sealing member may be formed integrally with the supply port member. According to this aspect, the second sealing member can be provided while suppressing an increase in the number of components.

8. According to a second aspect of the present disclosure, there is provided a liquid supply system. The liquid supply system includes the cartridge according to the above aspect, a mounting portion configured to mount the cartridge, the mounting portion including a receiving portion configured to receive the supply port member and the covering member, and a third sealing member configured to seal between the receiving portion and the covering member. According to this aspect, even when the liquid leaks from the supply port, the liquid can be retained between the receiving portion and the covering member by the third sealing member. Therefore, the leakage of the liquid to the outside of the cartridge can be further reliably suppressed.

The present disclosure can be realized in an aspect of a liquid ejecting apparatus, a liquid ejecting system, and the like in addition to each aspect described above.

What is claimed is:

1. A cartridge comprising:
a liquid accommodating portion configured to accommodate liquid;
a supply port member having a supply port that communicates with the liquid accommodating portion and supplies the liquid to an outside of the liquid accommodating portion;
a first sealing member provided on an inner peripheral surface of the supply port;
a covering member configured to cover a portion of an opening surface of the supply port from an outside of the supply port; and
a second sealing member configured to seal a leakage path of the liquid outside the supply port, the leakage path being a gap between elements included in the cartridge.

2. The cartridge according to claim 1, wherein
the leakage path is the gap between the supply port member and the covering member, and
the second sealing member is disposed between the supply port member and the covering member.

3. The cartridge according to claim 2, wherein
the second sealing member is disposed between an end portion of the supply port member opposite to the liquid accommodating portion and the covering member in an orthogonal direction orthogonal to the opening surface.

4. The cartridge according to claim 3, wherein
the covering member is configured as a cap having a second engaging portion that engages with a first engaging portion provided at the end portion in the orthogonal direction, and is fixed to the supply port member by the engagement of the first engaging portion and the second engaging portion.

5. The cartridge according to claim 1, further comprising:
a case member configured to accommodate the supply port member, wherein
the leakage path is the gap between the case member and the covering member, and
the second sealing member is disposed between the case member and the covering member.

6. The cartridge according to claim 1, wherein
the second sealing member is configured integrally with the covering member.

7. The cartridge according to claim 1, wherein
the second sealing member is configured integrally with the supply port member.

8. A liquid supply system comprising:
the cartridge according to claim 1;
a mounting portion configured to mount the cartridge, the mounting portion including a receiving portion configured to receive the supply port member and the covering member; and
a third sealing member configured to seal between the receiving portion and the covering member.
